(19) United States
(12) Patent Application Publication
(10) Pub. No.: US 2010/0114725 A1
(43) Pub. Date: May 6, 2010

(54) Electronic self-service terminal for point of sale

(76) Inventor: Jose Manuel Diaz Vidal, Betanzos (A Coruna) (ES)

Correspondence Address: WENDEROTH, LIND & PONACK, L.L.P., 1030 15th Street, N.W.,, Suite 400 East, Washington, DC, 20005-1503, US

(21) Appl. No.: 12/314,885

(22) Filed: Dec. 18, 2008

(30) Foreign Application Priority Data
Oct. 30, 2008 (FR) 08 57395

(51) Int. Cl. G06Q 30/00; G06Q 50/00

(52) U.S. Cl. 705/24

(57) ABSTRACT

The invention relates to an electronic self-service terminal for point of sale, preferably intended for recharging of mobile telephones. The terminal presents certain characteristics permitting the operations proper to a self-service terminal or point of sale to be individualized with other functions such as messages and/or publicity. Structurally, the terminal includes two screens (2) and (3), the first of them being touch-sensitive for carrying out certain operations (acquisition of product, charging of a mobile phone, etc.) by means of the corresponding keying on the touch-sensitive keys appearing on said screen (2). The screen (3) is intended for publicity, being located in the vertical position at the height of the user's eyes; while the aforementioned screen (2) is located in a lower position in an inclined plane. The displaying of publicity on the screen (3) is done independently, though simultaneously, with the carrying out of the operations on the screen (2).

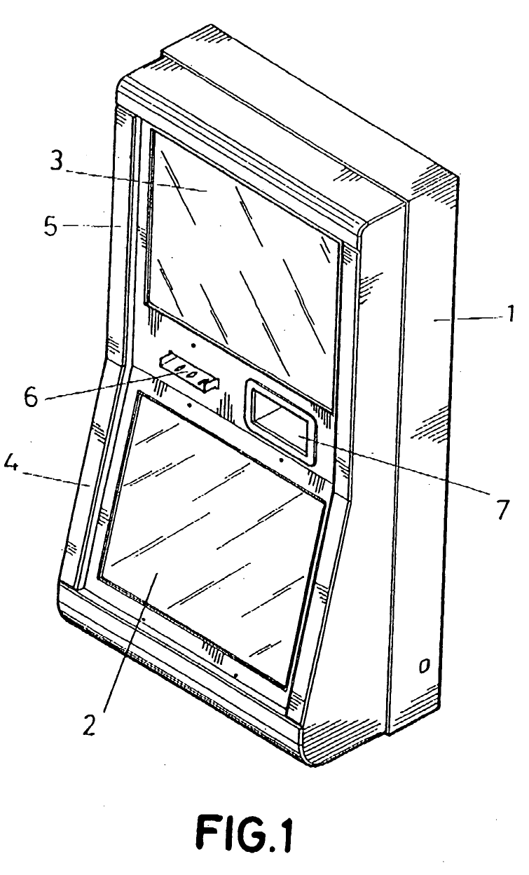

The body (1) of the terminal includes a CPU, printer and other electronic means for issuing print-outs of receipts via a slot (7) and for detecting bank-bills that are introduced as payment through another slot (6).

### OBJECT OF THE INVENTION

As stated in the title of this descriptive specification, the present invention relates to an electronic self-service terminal for point of sale, preferably and fundamentally intended for recharging of mobile telephones, though without rejecting other applications in which its use is feasible.

The aim of the invention is to individualize the operations proper to a point of sale terminal with respect to other auxiliary functions, such as displaying messages and/or publicity.

### BACKGROUND OF THE INVENTION

There are currently numerous electronic self-service terminals for point of sale that are installed in establishments and/or public places, generally consisting of a cabinet with one configuration or another and with a front screen via which the different operations to effect are displayed, managed and controlled.

Among the point of sale terminals are those that are fundamentally intended for the recharging of mobile telephones for different operators, as well as sale of pre-paid international call cards, sale of lottery tickets, etc., such that when these self-service terminals are located inside a commercial establishment they allow the owner thereof to obtain an income without having to devote any time to it, since the customer can recharge his or her mobile phone by using the terminal screen.

It is evident that these commercial products are based on the displaying of publicity which, evidently, it is not possible to display simultaneously with the operations that the customer carries out when charging their mobile phone or when conducting another operation, and this is a consequence of the fact that present-day terminals include a single screen without any possibility of being able to combine the functions proper to the terminal with additional activities of a publicity nature.

### DESCRIPTION OF THE INVENTION

The terminal that is disclosed presents the particular feature of including two front screens, an upper one and a lower one, defining separate independent displays, in such a way that one of them is touch-sensitive and allows the user or customer to conduct the appropriate operations, and at the same time the other screen displays any kind of publicity information, with the special feature that the two screens are located in different planes, one vertical and upper which corresponds to the publicity display screen, and the other in a position that is inclined backwards in the ascending direction, occupying the lower part and which is where the touch-sensitive movements are performed for the operations that the customer wishes.

Between the two screens is a space in which a slot is provided for the introduction and corresponding reading of bank-bills, along with a slot for the exit of print-outs as receipts for the operation.

Naturally, the terminal will incorporate inside it the appropriate electronics for communication with the central servers or corresponding operators, likewise including a CPU, power supply source, bank-bills holder, printer, etc., in order to carry out the different functions which the terminal itself is provided with.

In this way, and by means of said terminal embodied according to the object of the invention, the user or customer receives additional information while carrying out operations such as, for example, the recharging of mobile phones or other operations, without interruption, which grants the terminal a functionality with a greater versatility and quickness in carrying out the operations in comparison with conventional terminals.

Finally, it can be said that the terminal is preferably connected via the Ethernet to a central host which controls both the upper graphic information and the online communication with the different operators.

### BRIEF DESCRIPTION OF THE DRAWINGS

In order to complement the description that is going to be made forthwith, and with the aim of aiding a better understanding of the characteristics of the invention, this descriptive specification is accompanied by a single sheet of drawings on the basis of which the innovations and advantages of the terminal forming the object of the invention will be more easily understood.

In the sole figure represented in the said sheet of drawings, there appears a perspective view of the electronic self-service terminal for point of sale embodied according to the object of the invention.

### PREFERRED EMBODIMENT OF THE INVENTION

As can be seen in the referred figure, the self-service terminal of the invention comprises a body 1 which can be regarded as having a rectangular prismatic general configuration, defining a kind of cabinet, the front of which includes two planes 4 and 5, the first of them being lower and inclined backwards in the ascending direction, and other one being upper and lying in a vertical plane, such that separate screens 2 and 3 are positioned in these planes, the first of them touch-sensitive for allowing certain types of operations to be carried out by means of touch, whether this be the acquisition of a product, the charging of a mobile phone, etc., with the corresponding keying and operations being carried out on the touch-sensitive keys that appear in the said screen.

The second screen 3 is in the vertical position and is intended for publicity, being located normally at the height of the user's eyes so that when the user is carrying out the appropriate operations he or she can, without interruptions, watch any kind of publicity appearing in the said upper screen 3.

Said terminal includes a slot 6 with a bank-bills detector, and slot 7 for the issuing of print-outs as receipts for the appropriate operations, for which provision has been made for the inside of the cabinet or body 1 of the terminal to a CPU, appropriate electronics, printer, power supply source, etc.

1. ELECTRONIC SELF-SERVICE TERMINAL FOR POINT OF SALE, which, being intended for its introduction in commercial establishments for permitting different types of operations to be carried out, such as recharging of mobile telephones, and being connected via the Ethernet to a central host which controls both the graphic information and the online communication with the different operators, including a bank-bills reader comprising a front slot and a printer for issuing print-outs as receipts for the operations conducted; wherein the terminal comprises two screens (2 and 3) in the front, one of them touch-sensitive for permitting operations to be carried out by users, and the other for the displaying of publicity, simultaneously and independently of the carrying out of the operations.

2. ELECTRONIC SELF-SERVICE TERMINAL FOR POINT OF SALE, according to claim 1, wherein the screen (2) is touch-sensitive and is located below in an inclined plane (4) with an ascending inclination backwards, while the screen (3) located above the previous one is vertical.
